(19) United States
(12) Patent Application Publication
(10) Pub. No.: US 2015/0113808 A1
(43) Pub. Date: Apr. 30, 2015

(54) METHOD FOR MANUFACTURING HEAT PIPE WITH ULTRA-THIN CAPILLARY STRUCTURE

(71) Applicant: Hao PAI, New Taipei City (TW)

(72) Inventor: Hao PAI, New Taipei City (TW)

(21) Appl. No.: 14/145,505

(22) Filed: Dec. 31, 2013

(30) Foreign Application Priority Data
Oct. 29, 2013 (TW) 102139177

(51) Int. Cl. B23P 15/26; F28D 15/04

(52) U.S. Cl. CPC B23P 15/26; F28D 15/04
USPC 29/890.032

(57) ABSTRACT

A method for manufacturing a heat pipe with an ultra-thin capillary structure comprises the steps of: (a) preparing a hollow tube body, and pre-manufacturing a capillary structure that is shaped as a thin plate, the capillary structure having an adhering surface attached to a partial portion of an inner wall of the tube body and a forming surface that is opposite to the adhering surface; (b) disposing the capillary structure into the tube body so as to let the adhering surface be attached to the partial portion of the inner wall of the tube body for positioning; and (c) pressing the tube body in order to let the inner wall of the tube body urge on a partial portion of the forming surface of the capillary structure, and a vapor channel being formed between the capillary structure and the inner wall of the tube body.

### BACKGROUND OF THE INVENTION

1. Field of the Invention

The present invention generally relates to a method for manufacturing a heat-transfer device, more particularly to a method for manufacturing a heat pipe with an ultra-thin capillary structure.

2. Description of the Prior Art

Nowadays, electronic products are tending to small volumes in order to be easily carried. Since the volumes are smaller, some kinds of electronic products that need to dissipate heat inside should focus on the issue of the volume of a heat pipe. In order to minimize the heat pipe in the electronic products, an ultra-thin heat pipe, which has thickness under 1.5 mm, is then developed.

However, a capillary structure inside the ultra-thin heat pipe shall follow the design tendency to be smaller as well. To design the capillary structure, it may focus on the inner space of a heat pipe in order to avoid that the inner space is too small to let air or a fluid be through. That is, when an ultra-thin heat pipe is manufactured in a sintering process, its volume is designed very small to cause that metal powders are not able to be through a gap between a mandrel bar and the inner wall of the ultra-thin heat pipe, and part of the metal powders may not be positioned in the ultra-thin heat pipe. That is why a powdered capillary structure of an ultra-thin heat pipe is only formed at a location of the heat pipe without completion in prior arts. As a conclusion, a sectional surface of an ultra-thin heat pipe is hardly covered by the powdered capillary structure in prior arts. As it can be seen, this kind of powdered capillary structure may be short of a better vaporization surface area, a better condensation surface area, a better liquid transmission sectional surface area, a fluent vapor channel, and a reinforced supporting structure, and we would know the prior ultra-thin heat pipe should be improved in the aspect of heat transfer. Obviously, according to above descriptions, the capillary structure is difficult to be effectively positioned in the ultra-thin heat pipe, and it is very possible the capillary structure is shifted from a predetermined location of a heat transfer structure of the ultra-thin heat pipe. Subsequently, an effective space of a vapor channel may not be possibly formed so as to be failed in the aspect of heat transfer.

Accordingly, how to improve the heat transfer of an ultra-thin heat pipe in prior arts is an important issue to the people skilled in the art.

### SUMMARY OF THE INVENTION

In one aspect, the present invention is to provide a method for manufacturing a heat pipe with an ultra-thin capillary structure. It is to form a miniaturized capillary structure on an inner wall of a heat pipe in order to maintain an enough space of a vapor channel for heat exchange, for example vaporization and condensation. Furthermore, under the conditions of the heat pipe with a largest capillary surface area and a liquid transmission sectional area, the capillary structure can be accurately positioned on a predetermined location without occupying the space of the vapor channel and obtain a better performance in the aspect of sintering strength in order to reduce the heat resistance of the heat pipe.

In order to achieve the above aspect, the method for manufacturing a heat pipe with an ultra-thin capillary structure provided by the present invention comprises the steps of:
(a) preparing a hollow tube body, and pre-manufacturing a capillary structure that is shaped as a thin plate, the capillary structure having an adhering surface attached to a partial portion of an inner wall of the tube body and a forming surface that is opposite to the adhering surface;
(b) disposing the capillary structure into the tube body so as to let the adhering surface be attached to the partial portion of the inner wall of the tube body for positioning; and
(c) pressing the tube body in order to let the inner wall of the tube body urge on a partial portion of the forming surface of the capillary structure, and a vapor channel being formed between the capillary structure and the inner wall of the tube body.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a flow chart of the present invention;

FIG. 2 illustrates a schematic sectional view of a pre-manufactured capillary structure according to the present invention;

FIG. 3 illustrates a schematic view of using a mold to sinter a pre-manufactured capillary structure according to the present invention;

FIG. 4 illustrates a schematic view of using a die to extrude the pre-manufactured capillary structure according to the present invention;

FIG. 5 illustrates another schematic view of using a die to extrude the pre-manufactured capillary structure the according to present invention;

FIG. 6 illustrates a schematic view of disposing and positioning the pre-manufactured capillary structure according to the present invention;

FIG. 7 illustrates a schematic view of using a fixture to position and sinter the pre-manufactured capillary structure according to the present invention;

FIG. 8 illustrates a sectional view of pressing a heat pipe according to the present invention;

FIG. 9 illustrates a schematic sectional view of the pre-manufactured structure according to another preferred embodiment of the present invention;

FIG. 10 illustrates a schematic view of using a mold to sinter the pre-manufactured capillary structure according to another preferred embodiment of the present invention;

FIG. 11 illustrates a schematic view of using a die to extrude the pre-manufactured capillary structure according to another preferred embodiment of the present invention;

FIG. 12 illustrates another schematic view of using a die to extrude the pre-manufactured capillary structure according to another preferred embodiment of the present invention;

FIG. 13 illustrates a schematic view of disposing and positioning the pre-manufactured capillary structure according to another preferred embodiment of the present invention;

FIG. 14 illustrates a schematic view of using a fixture to position and sinter the pre-manufactured capillary structure according to another preferred embodiment of the present invention; and

FIG. 15 illustrates a sectional view of pressing a heat pipe according to another preferred embodiment of the present invention.

### DETAILED DESCRIPTION OF THE INVENTION

Following preferred embodiments and figures will be described in detail so as to achieve aforesaid objects.

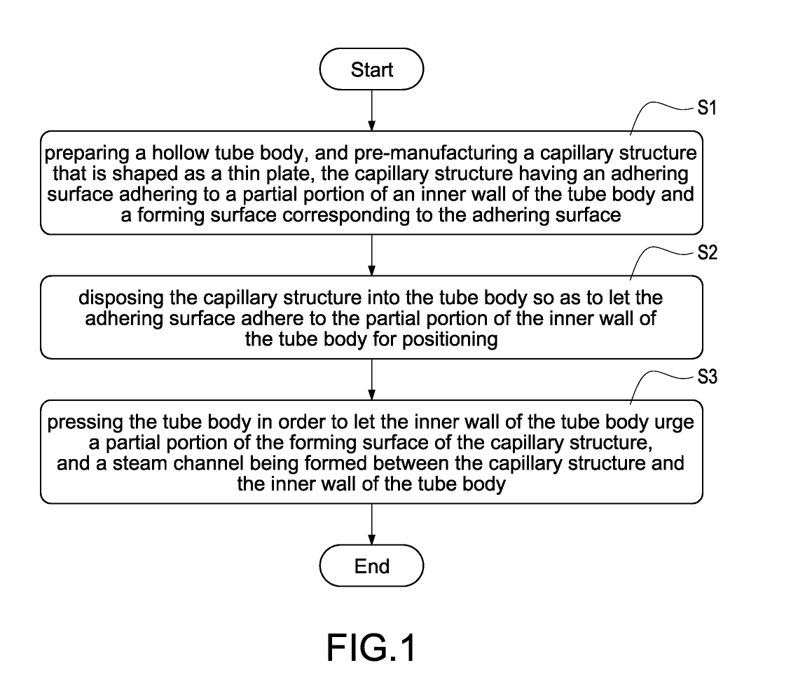

Please refer to FIG. 1, which is a flow chart of the present invention. The method for manufacturing a heat pipe with an ultra-thin capillary structure provided by the present invention has following steps that are described below.

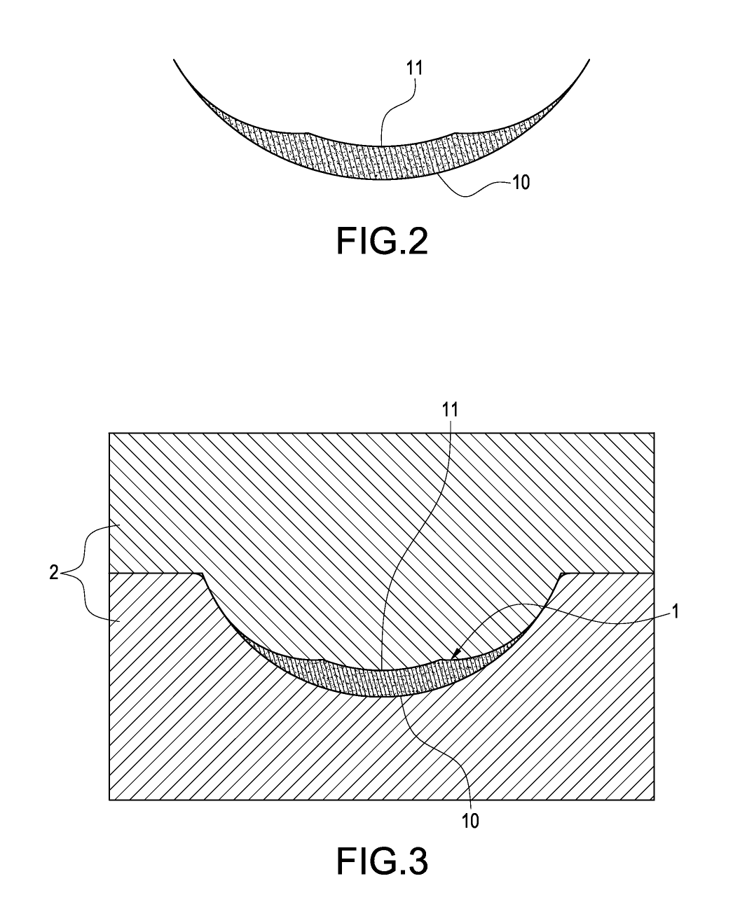

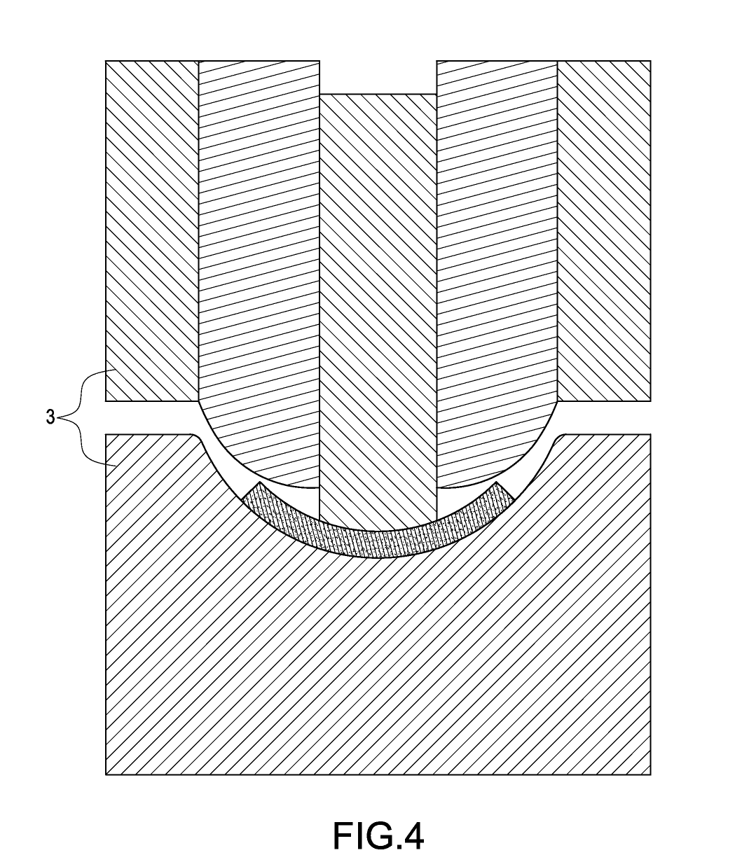

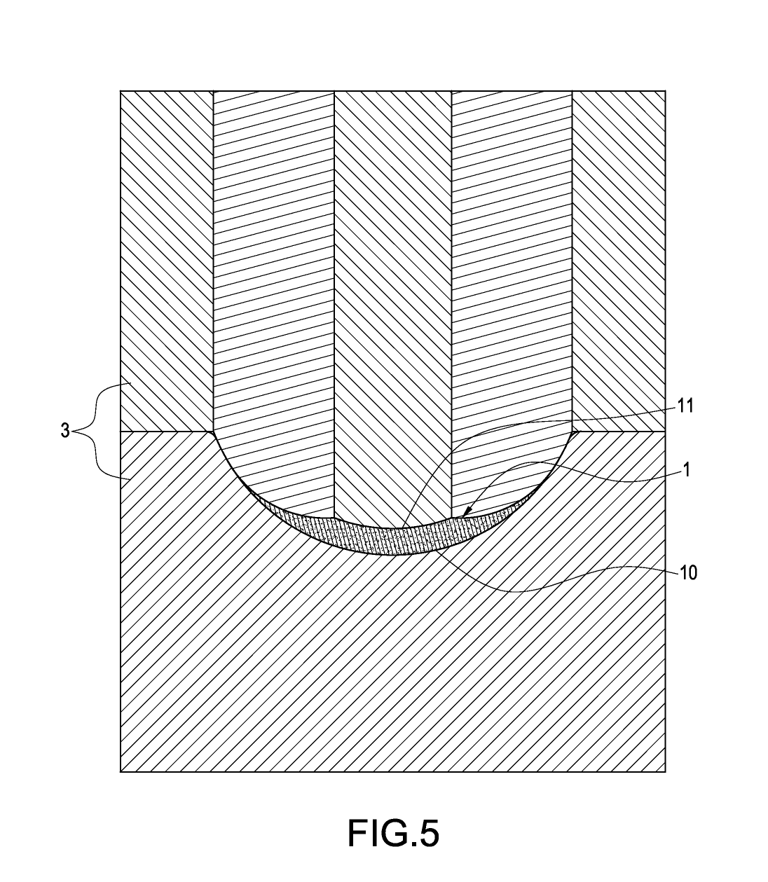

First, the step (S1) as shown in FIG. 1 is to prepare a hollow tube body 4 and to pre-manufacture a capillary structure 1 that is shaped as a thin plate. As shown in FIG. 2, the capillary structure 1 has an adhering surface 10 that is going to be attached to a partial portion of an inner wall of the tube body 4 and a forming surface 11 that is opposite to the adhering surface 10 and is shaped as continuously concave arcs. The capillary structure 1 is pre-manufactured by a sintering process or a pressing process. As shown in FIG. 3, sintering metal powders or fibers in a sintering mold 2 are to construct a capillary structure, and then the capillary structure 1 is done when it is taken out from the sintering mold 2. Referring to FIG. 4 and FIG. 5, there is another way to obtain the capillary structure 1, that is, the metal powders or fibers can be sintered and be bent as a curved thin plate, and then the curved thin plate is disposed into an extrusion die 3 to form the capillary structure 1.

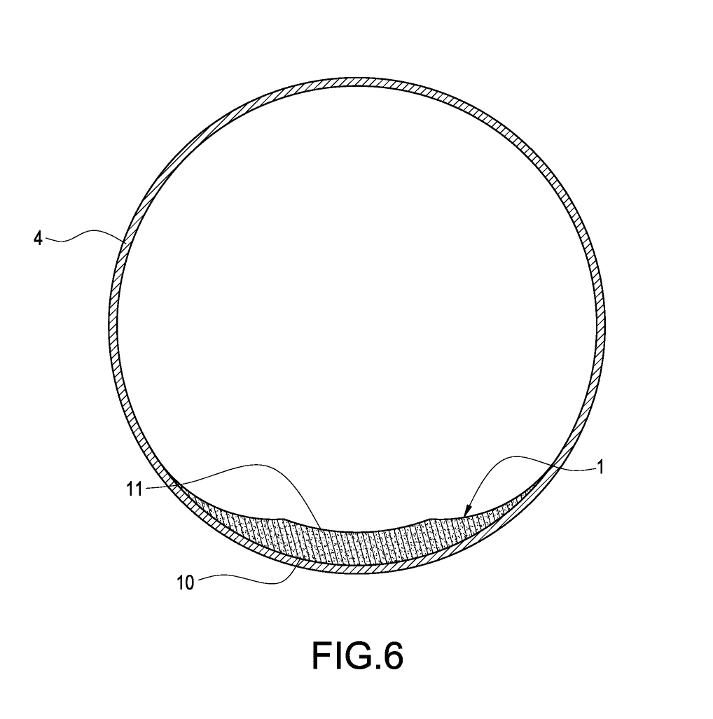

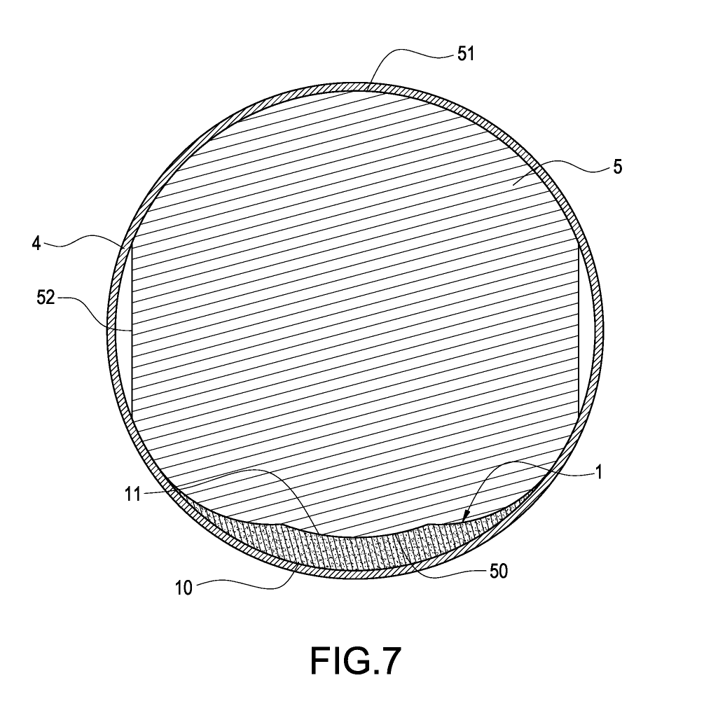

Referring to FIG. 6 and the step (S2) as shown in FIG. 1, the capillary structure 1 is disposed into the tube body 4, and the adhering surface 10 of the capillary structure 1 is attached to the partial portion of the inner wall of the tube body 4 for positioning, in particular, to position the capillary structure 1 through a fixture 5. As shown in FIG. 7, the fixture 5 is a rod member and is in the tube body 4; furthermore, the fixture 5 has a relative surface 50 and an abutting surface 51, the relative surface 50 corresponds to the forming surface 11 of the capillary structure 1, and the abutting surface 51 is opposite to the relative surface 50 and urges on the inner wall of the tube body 4. Additionally, a reserved gap 52 is formed between the fixture 5 and the inner wall of the tube body 4 after the fixture 5 is disposed in the tube body 4 so as to reduce the friction force. Subsequently, as aforesaid, the adhering surface 10 of the capillary structure 1 is attached to the partial portion of the inner wall of the tube body 4 through a sintering process, etc., so that the capillary structure 1 is securely positioned in the tube body 4.

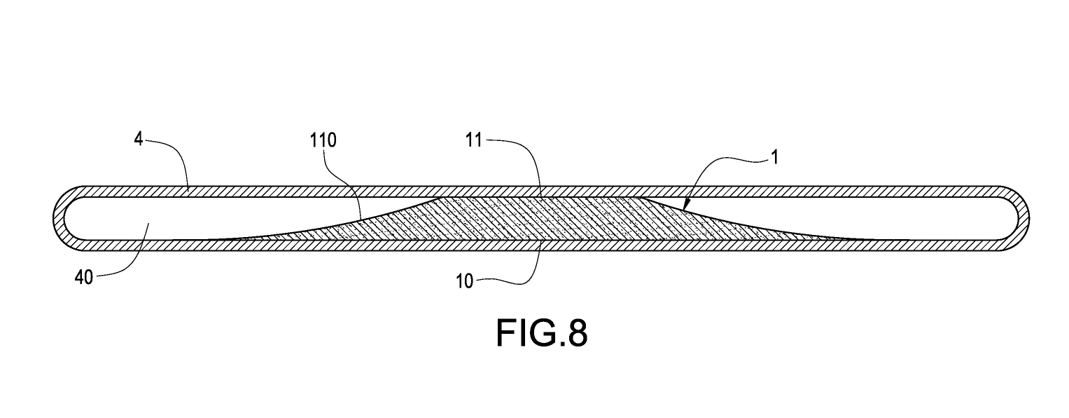

Please refer to FIG. 8 and the step (S3) as shown in FIG. 1, the tube body 4 is pressed so as to let the inner wall of the tube body 4 urge on a partial portion of the forming surface 11 of the capillary structure 1, and a vapor channel 40 is formed between the capillary structure 1 and the inner wall of the tube body 4. In this embodiment, two sides of the forming surface 11 of the capillary structure 1 elongate to form two capillary transmission surfaces 110, respectively, and each of the capillary transmission surfaces 110 enlarges a contact surface between the capillary structure 1 and the vapor channel 40, so as to reduce flow resistance of vapor flow in the vapor channel 40, and increase a capillary surface area of working fluid flowing back to the capillary structure 1, in order to achieve a better heat-exchange effect as the heat pipe is miniaturized.

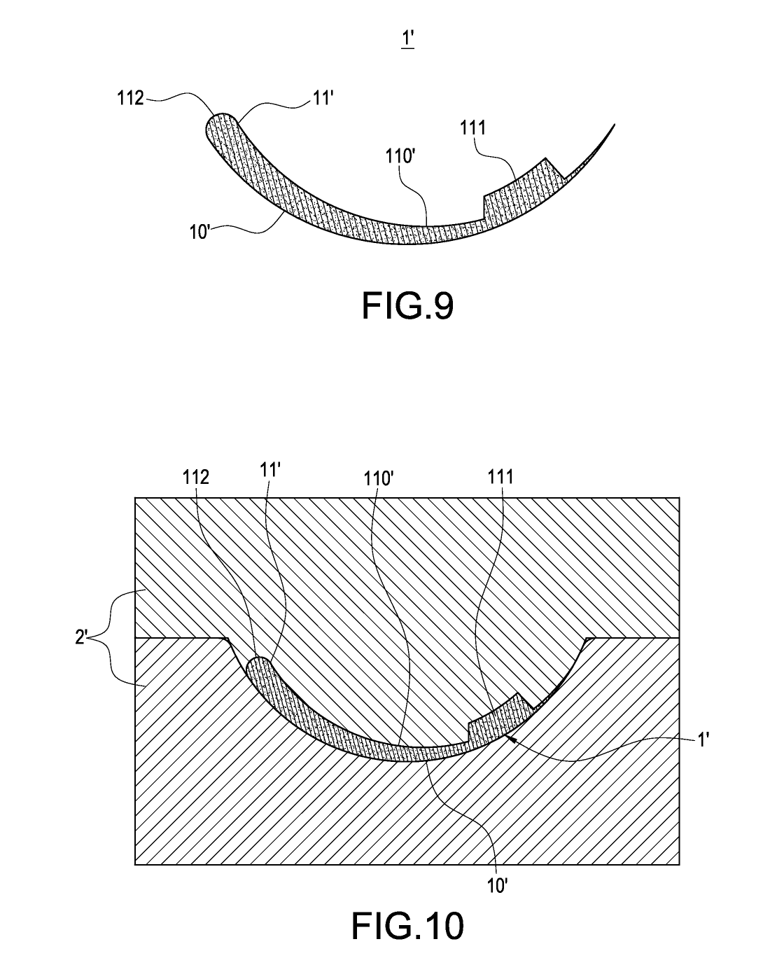

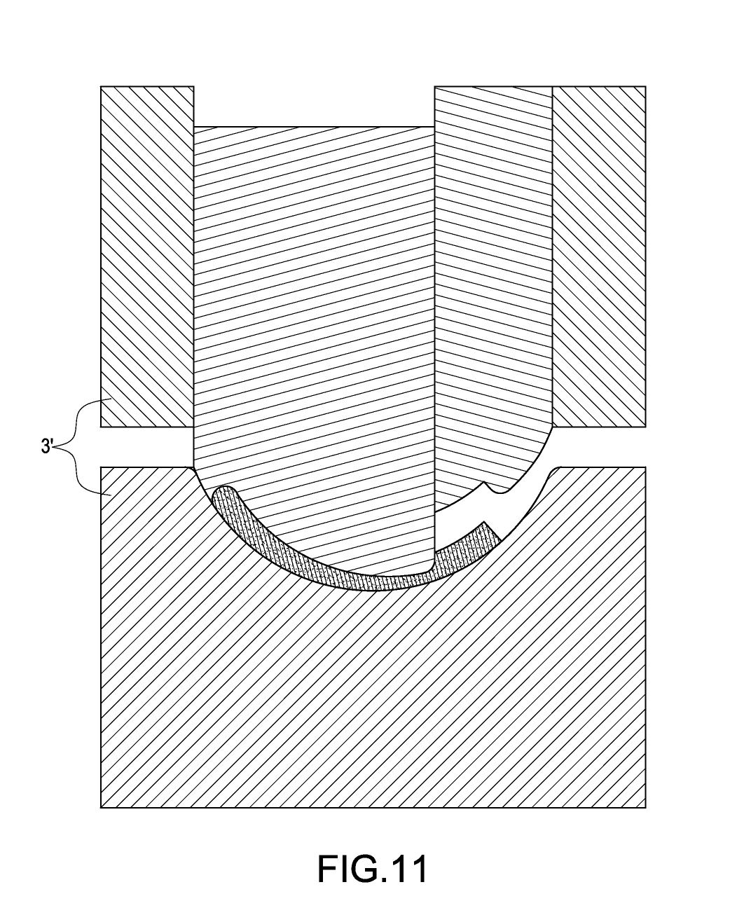

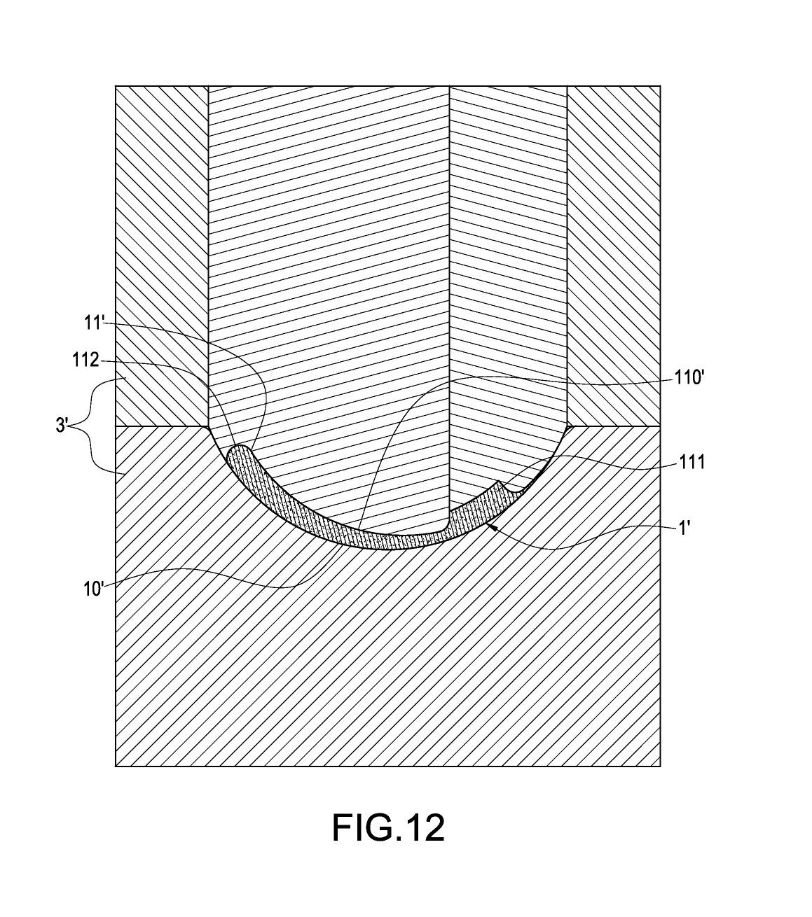

In another preferred embodiment, as shown in FIG. 9, the capillary structure 1′ includes an adhering surface 10′ and a forming surface 11′ and has a tapered shape, i.e. the thickness of the capillary 1′ is gradually reduced from one top edge 112 to the other end edge, wherein the adhering surface 10′ is opposite to the forming surface 11′. Moreover, a supporting portion 111 is protruded from the capillary transmission surface 110′. Similarly, the capillary structure 1′ is pre-made by the sintering process or the pressing process. As shown in FIG. 10, sintering metal powders or fibers in a sintering mold 2′ is to construct the capillary structure 1′, and then the capillary structure 1′ is done when it is taken out from the sintering mold 2′. Referring to FIG. 11 and FIG. 12, there is another way to obtain the capillary structure 1′, that is, the metal powders or fibers can be sintered and be bent as a curved thin plate, and then the curved thin plate is disposed into an extrusion die 3′ to form the capillary structure 1.

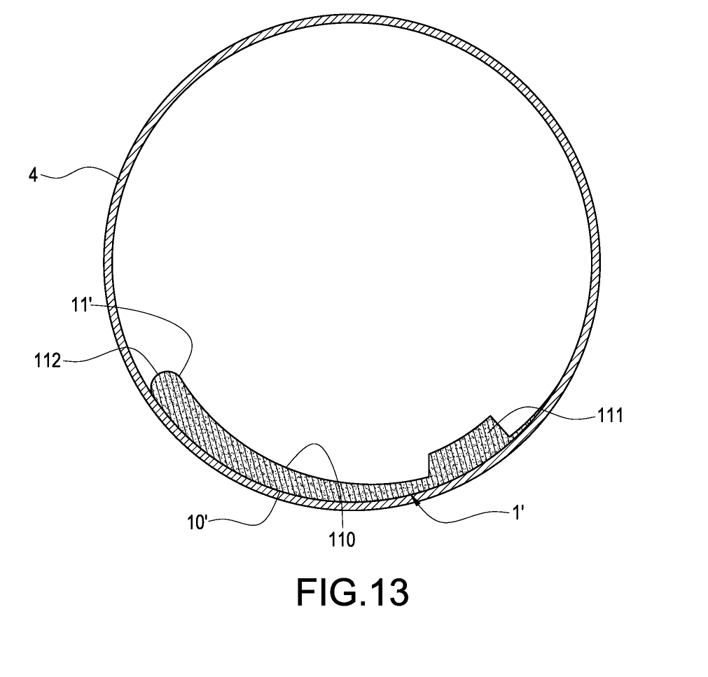

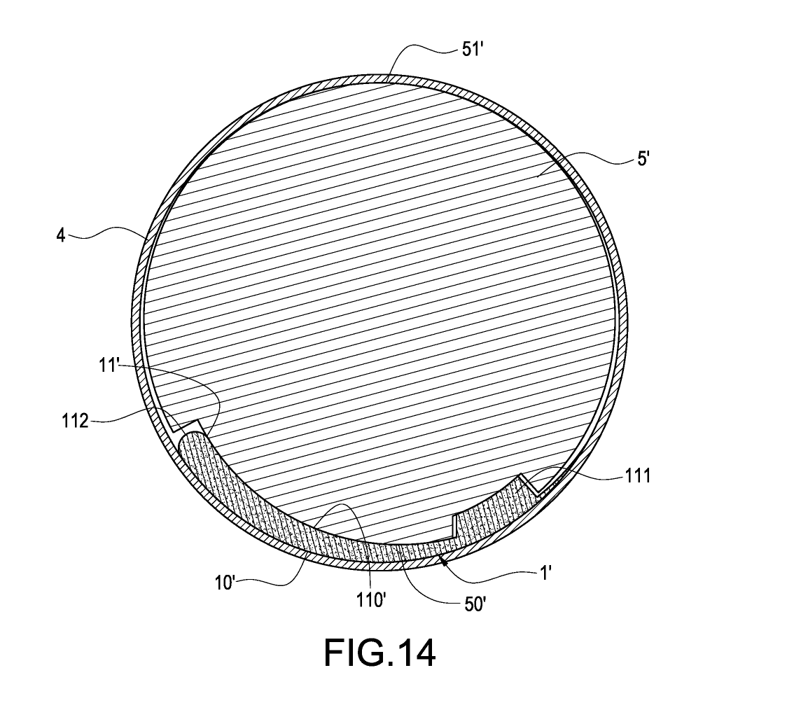

Referring to FIG. 13, similarly, the capillary structure 1′ is disposed in the tube body 4 in order to let the adhering surface 10 of the capillary structure 1′ be attached to and positioned on the partial portion of the inner wall of the tube body 4 through the fixture 5′. As shown in FIG. 14, the fixture 5′ has the relative surface 50′ and the abutting surface 51′, wherein the relative surface 50′ corresponds to the forming surface 11′ of the capillary structure 1′, and the abutting surface 51′ is opposite to the relative surface 50′ and urges on the inner wall of the tube body 4. By means of a sintering process, etc., the adhering surface 10 of the capillary structure 1′ is securely fixed to the partial portion of the inner wall of the tube body 4.

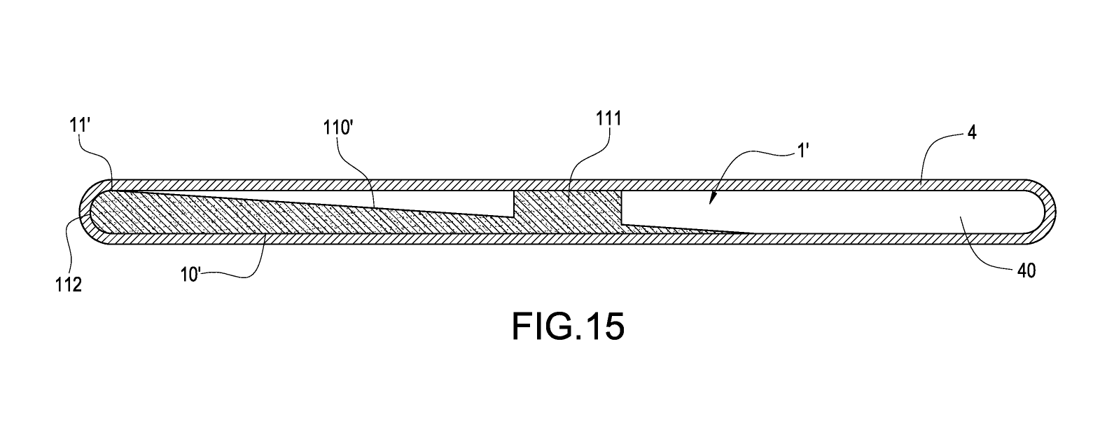

With reference to FIG. 15, pressing the tube body 4 will urge the inner wall of the tube body 4 on the supporting portion 111; additionally, an inner side wall of the tube body 4 is urged on the top edge 112; thus, the vapor channel 40 is formed between the capillary transmission surface 110 and the inner side wall of the tube body 4.

As a conclusion, according to the above structures, we would develop the method for manufacturing a heat pipe with an ultra-thin capillary structure.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims.

What is claimed is:

1. A method for manufacturing a heat pipe with an ultra-thin capillary structure, comprising the steps of:
(a) preparing a hollow tube body (4), and pre-manufacturing a capillary structure (1 or 1′) that is shaped as a thin plate, the capillary structure (1 or 1′) having an adhering surface (10 or 10′) attached to a partial portion of an inner wall of the tube body (4) and a forming surface (11 or 11′) that is opposite to the adhering surface (10 or 10′);
(b) disposing the capillary structure (1 or 1′) into the tube body (4) so as to let the adhering surface (10 or 10′) be attached to the partial portion of the inner wall of the tube body (4) for positioning; and
(c) pressing the tube body (4) in order to let the inner wall of the tube body (4) urge on a partial portion of the forming surface (11 or 11′) of the capillary structure (1 or 1), and a vapor channel being formed between the capillary structure (1 or 1′) and the inner wall of the tube body (4).

2. The method for manufacturing a heat pipe with an ultra-thin capillary structure according to claim 1, wherein the capillary structure (1 or 1′) in step (a) is pre-manufactured by a sintering process or a pressing process.

3. The method for manufacturing a heat pipe with an ultra-thin capillary structure according to claim 2, wherein the capillary structure (1 or 1′) is pre-manufactured through a sintering mold (2).

4. The method for manufacturing a heat pipe with an ultra-thin capillary structure according to claim 2, wherein the capillary structure (1 or 1′) is pre-formed as a curved thin plate through sintering metal powders or fibers, and then is disposed into an extrusion die (3) for shaping.

5. The method for manufacturing a heat pipe with an ultra-thin capillary structure according to claim 1, wherein two sides of the forming surface (11) of the capillary structure (1) elongate to form two capillary transmission surfaces (110) respectively, each of the capillary transmission surfaces (110) and the forming surface (11) being shaped as continuously concave arcs.

6. The method for manufacturing a heat pipe with an ultra-thin capillary structure according to claim 1, wherein the capillary structure (1′) has a tapered shape to have a thickness thereof gradually reduced from one top edge (112) to the other end edge.

7. The method for manufacturing a heat pipe with an ultra-thin capillary structure according to claim 6, wherein the capillary transmission surface (110′) has a supporting portion (111).

8. The method for manufacturing a heat pipe with an ultra-thin capillary structure according to claim 1, wherein a fixture (5 or 5′) is used to position the capillary structure (1 or 1′) in step (b).

9. The method for manufacturing a heat pipe with an ultra-thin capillary structure according to claim 8, wherein the fixture (5 or 5′) is a rod member and is in the tube body (4), the fixture (5 or 5′) having a relative surface (50 or 50′) and an abutting surface (51 or 51′), the relative surface (50 or 50′) corresponding to the forming surface (11 or 11′) of the capillary structure (1 or 1′), and the abutting surface (51 or 51′) being opposite to the relative surface (50 or 50′) and urging on the partial portion of the inner wall of the tube body (4).

10. The method for manufacturing a heat pipe with an ultra-thin capillary structure according to claim 9, wherein a reserved gap (52) is between the fixture (5) and the inner wall of the tube body (4) after the fixture (5) is disposed in the tube body (4).
